(19) United States
(12) Patent Application Publication
(10) Pub. No.: US 2003/0136508 A1
(43) Pub. Date: Jul. 24, 2003

(54) Method of manufacturing a buffing pad

(76) Inventor: Richard A. Kaiser, Hartland, WI (US)

Correspondence Address: ANDRUS, SCEALES, STARKE & SAWALL, LLP, 100 EAST WISCONSIN AVENUE, SUITE 1100, MILWAUKEE, WI, 53202, US

(21) Appl. No.: 10/055,777

(22) Filed: Jan. 23, 2002

(51) Int. Cl. B32B 31/20

(52) U.S. Cl. 156/309.9

(57) ABSTRACT

A polyethylene back-up plate is attached directly to the rear surface of a rotary foam buffing pad or to an intermediate polyethylene layer on the back of any of several types of rotary buffing pads utilizing a permanent heat bond.

### BACKGROUND OF THE INVENTION

The present invention pertains to rotary surface finishing pads made of various materials and, more particularly, to such a finishing pad in which a polyethylene backing member is heat bonded directly to the back surface of the pad.

Polymeric foam pads are well known in the art of surface finishing and one particularly suitable material comprises an open cell polyurethane foam. Rotary foam pads of open cell polyurethane foam are widely used for polishing and buffing automotive body surface finishes. These pads are typically attached to a somewhat more rigid circular back-up plate which, in turn, is demountably attached to the drive spindle of a power buffing tool. Most commonly, an intermediate circular backing layer is permanently attached to the rear surface of the foam buffing material, and the opposite face of the backing layer is provided with half of a hook and loop fastening system. A circular back-up plate has a front face that carries the other half of the hook and loop fastening system to which the backing disk and attached foam pad are demountably attached. The backing plate, in turn, is mounted to a power buffing tool with any of the mounting arrangements well known in the art.

Rotary surface finishing pads are made of other materials, including tufted wool fibers, other natural and synthetic fibers, and densely packed polymeric foam fingers. These types of pads typically have a backing layer of jute or a similar material to which strands are sewn and that backing layer is in turn covered with a polyethylene layer which may seal the stitches in the tufted fibers, be heat formed to impart a particular shape to the buffing pad, or simply to provide additional rigidity.

The intermediate demountable mechanical fastening systems by which most rotary finishing pads are attached to the driven back-up plates tend to be complex and include a significant number of parts. It is believed that, by simplifying construction of various connections and providing connector pieces that are disposable with the used pads, finishing pad systems could be considerably simplified and, in some cases, the replacement procedure simplified as well.

### SUMMARY OF THE INVENTION

The basic method of the present invention for attaching a back-up plate member to the planar back face of a rotary buffing pad includes the steps of (1) providing a back-up plate member made of a polyethylene material and having a generally planar attachment surface, (2) heating the attachment surface to the melting point of the polyethylene material, and (3) pressing the heated attachment surface to the planar back face of the pad to form a heat bond. In one embodiment, if the buffing pad comprises an open cell polyurethane foam, the pressing step includes forcing the heated polyethylene material into the open cells of the polyurethane foam. If the back face of the buffing pad comprises a backing layer of polyethylene material, the method may include, prior to the pressing step, the step of heating the exposed surface of the polyethylene layer to the melting point of the polyethylene material. Where the diameter of the back-up plate surface is smaller than the diameter of the buffing pad backing layer, the heating step preferably comprises heating a center circular area of the buffing pad layer generally corresponding in diameter to the diameter of the back-up plate surface.

In accordance with a further embodiment of the present invention a method is provided for mounting a backing member to the surface of an open pore polyurethane foam buffing pad which method comprises the steps of (1) providing a backing member that is made of a polyethylene material, (2) heating a surface portion of the backing member to its melting temperature and, (3) pressing the heated surface portion against the surface of the foam pad to force the melted polyethylene into the open pores of the polyurethane foam to form a heat bond. The surface portion of the backing member is preferably generally planar and the member further includes a generally planar back surface, and the method includes the further steps of (1) providing a back-up plate of a polyethylene material having a planar front face, (2) heating the back-up plate front face and the backing member back surface to the melting temperature of the polyethylene material, and (3) pressing the heated front face and back surface together to form a heat bond.

The method of the present invention may also include the steps of (1) forming the pad and the backing member with circular peripheral edges, and (2) during the step of pressing the heated surface portion against the surface of the foam pad, forming the peripheral edge of the surface portion with an upturned convex shape to form a heat bonded upturn pad edge. The method may also include the step of providing the back-up member with a back surface having a connector for attachment to a pad driver. The polyethylene material preferably comprises a high density polyethylene.

### BRIEF DESCRIPTION OF THE DRAWINGS

FIG. 1 is a generally schematic representation of the basic method of the present invention for attaching a polyethylene backing member directly to a foam buffing pad.

FIGS. 1A and 2 together provides a schematic representation of a further embodiment of the method of the present invention.

FIGS. 3 and 4 are side elevation views of two types of back-up plates which may be attached to a foam buffing pad in accordance with the method of either FIG. 1 or FIG. 2.

FIG. 5 is an isometric view of a buffing pad having a back-up member attached thereto in accordance with the method steps of FIGS. 1A and 2.

FIG. 6A is a sectional view of a pad after completion of the FIG. 1A portion of the method.

FIG. 6B is a sectional view of the pad, taken on line 6-6 of FIG. 5, after completion of the FIG. 2 portion of the method

### DETAILED DESCRIPTION OF THE PREFERRED EMBODIMENTS

It is known in the art to attach a polyethylene backing layer to the rear (non-working) face of a rotary buffing pad to, for example, seal the stitches in a tufted pad, provide upturned curved edges in both tufted and foam buffing pads, and to provide overall added rigidity to a pad. Such pads are mounted in use on a rotary backing plate which in turn is attached to a power buffing machine or similar driving device. Back-up plates are typically made of plastic or metal. Plastic back-up plates are most commonly made of a polypropylene material, but vinyl and styrene materials are also used. The pads are typically attached to the back-up plates with adhesives, hook and loop fastening systems, or other fasteners such as rivets. Such pad mounting systems require additional components and/or materials and, in some cases, are quite inconvenient for the operator when changing pads.

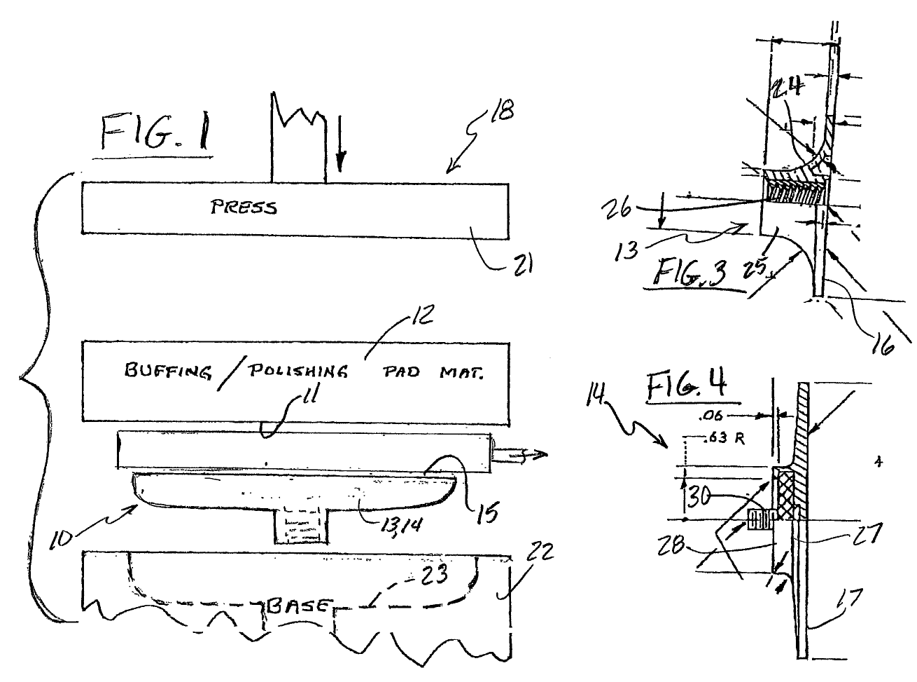

Referring first to FIG. 1, in accordance with the basic method of the present invention, a back-up plate member 10 made of a polyethylene material is attached with a heat bond to the planar rear face 11 of a rotary buffing pad 12 made of an open cell polyurethane foam material. It has been found that, among the many thermoplastic materials used in the art for backing materials or back-up plates for rotary buffing tools, only polyethylene provides a satisfactory bond directly to a polyurethane foam. This permits the back-up plate member 10, which may comprise various configurations as will be described, to be attached directly and permanently to the polyurethane foam pad 12.

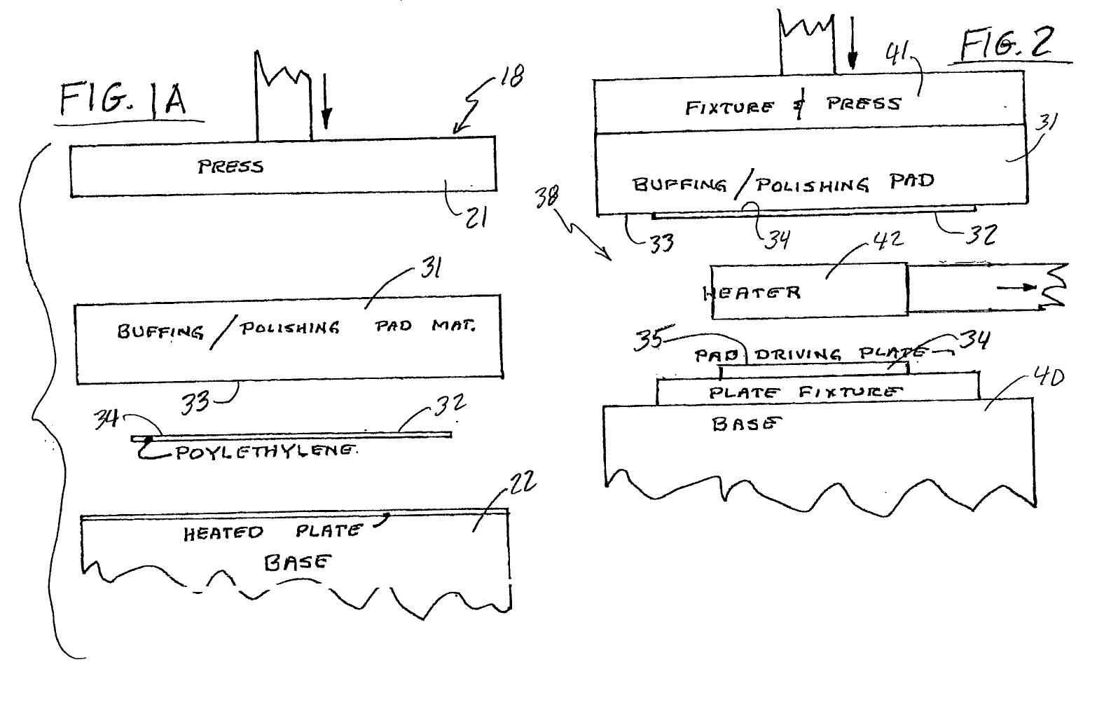

Referring also to FIGS. 3 and 4, the back-up plate member 10 may comprise a unitary back-up plate 13 (FIG. 3) or a similar unitary back-up plate 14 (FIG. 4). Any of such back-up plates 13 or 14 is represented in FIG. 1 as a back-up plate member 10 having at least one exposed planar surface 15. Thus, in the FIG. 3 embodiment, the back-up plate 13 has a generally planar mounting surface 16 and, in the FIG. 4 embodiment, the back-up plate 14 has a similar planar mounting surface 17.

In accordance with the FIG. 1 method, the back-up plate member 10 is mounted in a press 18 with its planar mounting surface 15 positioned opposite the planar rear face 11 of the foam buffing pad 12. A heating device 20 is positioned in the open press 18 close to the planar mounting surface 15 of the back-up plate member 10 where it raises the temperature of the surface 15 to at least the melting point of the polyethylene plastic material, for example, about 325 degrees F. (about 163 degrees C.). The heating device 20 is then withdrawn from the press and the press is closed by bringing an upper press member 21 vertically down toward a lower press member 22 and, while the polyethylene surface 15 remains at the melting temperature, the pad 12 and the back-up plate member 10 are brought together, forcing molten polyethylene material into the open pores of the foam buffing pad face 11. After cooling, the polyethylene back-up plate member 10 is permanently attached with a heat bond to the foam buffing pad 12.

In the FIG. 1 method, the lower press member 22 is provided with a recess 23 in which the back-up plate 13 or 14 is received when the press is closed. The FIG. 3 back-up plate 13, as also shown in FIG. 1, comprises a polyethylene body that includes the planar circular mounting surface 16 and an integral central mounting hub 25. As indicated, the polyethylene material is preferably a high density polyethylene (HDPE). A threaded metal nut is preferably insert molded in the hub 25 for direct attachment of the back-up plate to the threaded stub shaft of a power buffing machine (not shown). The back-up plate 14 of FIG. 4 is of a similar construction, including an HDPE body 27 comprising the planar mounting surface 17 and a central hub 28. A threaded stud 30 is insert molded in the hub 28 and is adapted for attachment to a tapped bore or the like on a power buffing machine.

FIGS. 1A and 2 show the combined steps for attaching a polyethylene back-up plate member to a buffing pad to which a layer of polyethylene or a polyethylene composite material is first attached. Thus, the buffing pad 31 may be any of the types commonly used for buffing, polishing or finishing a surface, including open cell polyurethane foam, a dense array of individual foam fingers, tufted wool fibers, and other materials. An intermediate polyethylene layer 32 may, for example, be initially attached to the rear face 33 of a foam buffing pad by heating the intermediate polyethylene layer 32 to its melting point and pressing it against the pad and into a suitable forming die (not shown) to form the peripheral edges of the pad 31 and intermediate polyethylene layer 32 into an upturned dish-shaped configuration, as shown in FIG. 6A. After the intermediate layer 32 has cooled, it retains its upturned edge shape and, by virtue of its melt bond to the foam material of the buffing pad 31, the pad edge is also retained in the upturned shape. This specific construction is well known in the art. The intermediate polyethylene layer 32 may also be applied to the backing layer of other types of pads 31, such as a jute backing of a tufted wool pad, also in a manner well known in the art. The result in any case, however, is a buffing pad construction as shown in FIG. 6A in which the pad 31 has an intermediate polyethylene layer 32 heat bonded thereto.

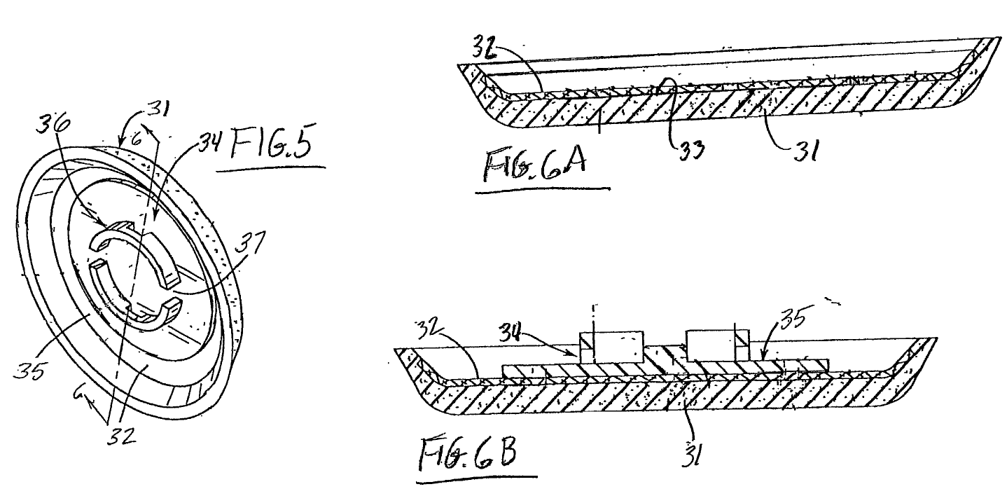

The next step of the method is shown in FIG. 2 where a back-up plate 34 of a polyethylene material (again, preferably, HDPE) is attached to the intermediate polyethylene layer 32 bonded to the pad 31 in the step of FIG. 1. The back-up plate 34 may be of the same type shown in FIG. 3 or FIG. 4. However, as shown in FIGS. 5 and 6B, the back-up plate 34 comprises an intermediate member of the type described in my co-pending application Ser. No. 09/593,427, filed Jun. 14, 2000, entitled Quick Mount Attachment for Rotary Finishing Tool. This back-up plate includes a circular planar mounting surface 35 and an integral central hub 36. The hub includes a mounting connector 37 adapted to cooperate with the other part of a mounting connector (not shown) of a system described in my above identified application for quick connection and disconnection to a power buffer.

Referring again to FIG. 2, the back-up plate 34 is supported in an inverted position on the lower press member 40 of a press 38 such that the planar mounting surface 35 is facing upwardly. The composite buffing pad 31 of FIG. 6a is mounted on an upper press member 41 with the intermediate polyethylene layer 32 facing downwardly. A heater 42 is positioned between the upper and lower members and is activated to heat to the melting point the polyethylene layer 32 on the pad 31 and the mounting surface 35 of the back-up plate 34. Typically, the diameter of the back-up plate mounting surface 35 is substantially smaller than the diameter of the intermediate backing layer 32 on the pad. To avoid remelting any more of the intermediate backing layer 32 than necessary, the heater 42 is sized to correspond to the back-up plate mounting surface 35 and will therefore heat only a similarly sized central portion of the buffing pad backing layer 32. After heating, the heater is withdrawn, the press is closed and the back-up plate 34 is connected with a heat bond to the center portion of the buffing pad backing layer 32. FIGS. 5 and 6B show the unitary assembly of buffing pad 31 and back-up plate 34.

By the direct heat bonding of a backing member to a rotary buffing pad, in accordance with the method and apparatus of this invention, the backing member can be very accurately centered on the pad. True centering of the pad and driver improves rotational balance of the assembly, resulting in decreased vibration and decreased operator fatigue. Demountable attachment of a backing member to a pad, for example with a hook and loop fastening system, does not always result in accurate centering. In addition, such demountable fastening systems may come apart in use, whereas the heat bond of the present invention provides a much stronger and more secure connection. Finally, it is possible to disassemble the polyethylene backing member from the pad by reheating to the melting temperature. In this manner, after a pad has become damaged, worn, or soiled beyond cleaning, the polyethylene backing member may be salvaged or recycled.

I claim:

1. A method for attaching a back-up plate member to the planar back face of a rotary buffing pad, said method comprising the steps of:
(1) providing a back-up plate member made of a polyethylene material and having a generally planar attachment surface;
(2) heating the attachment surface to the melting point of the polyethylene material; and,
(3) pressing the heated attachment surface to the planar back face of the pad to form a heat bond.

2. The method as set forth in claim 1 wherein the back face of the buffing pad comprises an open cell polyurethane foam, and including, during the pressing step, forcing the heated polyethylene material into the open cells of the polyurethane foam.

3. The method as set forth in claim 1 wherein the back face of the buffing pad comprise a backing layer of polyethylene material, and including, prior to the pressing step, the step of heating the exposed surface of the polyethylene layer to the melting point of said material.

4. The method as set forth in claim 3 wherein said backing layer of polyethylene on the buffing pad and the polyethylene attachment surface of the back-up plate are of a circular shape and the diameter of the back-up plate surface is smaller than the diameter of the buffing pad layer, wherein the heating step comprises heating a center circular area of said buffing pad layer generally corresponding in diameter to the diameter of the back-up plate surface.

5. A method for mounting a backing member to the surface of an open pore polyurethane foam buffing pad comprising the steps of:
(1) providing a backing member made of a polyethylene material;
(2) heating a surface portion of the backing member to its melting temperature; and,
(3) pressing the heated surface portion against the surface of the foam pad to force the melted polyethylene into the open pores of the polyurethane foam to form a heat bond.

6. The method as set forth in claim 5 wherein the surface portion of the backing member is generally planar and said member further includes a generally planar back surface, and including the steps of:
(1) providing a back-up plate of a polyethylene material having a planar front face;
(2) heating the back-up plate front face and the backing member back surface to the melting temperature of the polyethylene material; and,
(3) pressing the heated front face and back surface together to form a heat bond.

7. The method as set forth in claim 6 including the steps of:
(1) forming said pad and said backing member with circular peripheral edges; and,
(2) during the first recited pressing step, forming the peripheral edge of the surface portion with an upturned convex shape to form a heat bonded upturned pad edge.

8. The method as set forth in claim 5 including the step of providing said back-up member with a back surface having a connector for attachment to a pad driver.

9. The method as set forth in claim 5 wherein the polyethylene material comprises a high density polyethylene.
